(19) United States
(12) Patent Application Publication
(10) Pub. No.: US 2024/0171494 A1
(43) Pub. Date: May 23, 2024

(54) INTEGRATING SECURE RANGING BETWEEN WI-FI INTERNET-OF-THINGS (IOT) DEVICES INTO A DEVICE COMMISSIONING PROTOCOL

(71) Applicant: Cypress Semiconductor Corporation, San Jose, CA (US)

(72) Inventors: Hui LUO, Marlboro, NJ (US); Rakesh TAORI, McKinney, TX (US); Roman BAKER, Las Vegas, NV (US)

(73) Assignee: Cypress Semiconductor Corporation, San Jose, CA (US)

(21) Appl. No.: 17/990,069

(22) Filed: Nov. 18, 2022

(51) Int. Cl. H04L 43/16; H04L 9/08; H04L 43/0864

(52) U.S. Cl. CPC H04L 43/16; H04L 9/0825; H04L 9/085; H04L 43/0864

(57) ABSTRACT

Techniques for securely commissioning wireless internet-of-things (IoT) devices using estimates of the distance to the device to be commissioned. An example method, in a first device comprising a Wi-Fi station (STA), comprises the step of initiating or responding to initiation of a commissioning or provisioning procedure with a second device comprising a Wi-Fi STA, using Wi-Fi signaling, and determining an estimated distance or estimated round-trip travel time between the first and second devices, using timing information obtained from one or more messages exchanged between the first and second devices using Wi-Fi signaling. The example method further comprises determining whether to abort or continue with the commissioning or provisioning procedure, based on the estimated distance or estimated round-trip travel time.

### TECHNICAL FIELD

The present disclosure is generally related to wireless communications and is more particularly related to techniques for commissioning devices for use in a wireless network.

### BACKGROUND

The “Internet of Things” (IOT) refers to a wide and ubiquitous deployment of wireless-equipped sensors and controllers, for use in such applications as home and factory automation. Especially in the home environment, however, wide-spread deployment can easily be inhibited if it is difficult to connect the devices to the home network in a secure manner. To address this problem, several so-called commissioning protocols have been developed for connecting new devices to an existing home network or other network.

One of these commissioning protocols forms part of the broader Internet Protocol (IP)-based connectivity protocol called Matter, developed by the Connectivity Standards Alliance (CSA). This open-standard protocol supports both Wi-Fi and Thread-based networking, where the latter is a low-power mesh-based networking technology. Another commissioning protocol is the Device Provisioning Protocol (DPP) for Wi-Fi devices, developed by the Wi-Fi Alliance (WFA). Both of these commissioning protocols promise quick and easy commissioning.

However, making a commissioning protocol convenient and easy to use can put network security at risk. With current commissioning protocols for Wi-Fi IoT devices, it is often possible to commission the wrong device, which may be a malicious device, and authorize network access and privileges for that device. This can cause serious security breaches.

### SUMMARY

The use of Bluetooth® Low Energy or Near-Field Communication (NFC) technologies for commissioning of IoT inherently reduces the risk of commissioning the wrong IoT device, because the limited communication range of these technologies means that a device must be very close to the commissioning device, or “commissioner,” to engage in the commissioning protocol at all. However, this is not the case with Wi-Fi devices, which can have communication ranges of over one hundred feet. This extended range makes it easier for a commissioning protocol to commission an unauthorized device.

Embodiments of the techniques and devices described below address this problem by integrating a secure distance measurement procedure into the commissioning protocol. By preventing the commissioning of a Wi-Fi device unless it is within a certain range of the commissioner device, the chances of an unauthorized commissioning event are reduced, thus improving the security of the commissioning procedure.

An example method is carried out in a first device that comprises a Wi-Fi station (STA), and comprises the step of initiating or responding to initiation of a commissioning or provisioning procedure with a second device comprising a Wi-Fi STA, using Wi-Fi signaling. The method further comprises determining an estimated distance or estimated round-trip travel time between the first and second devices, using timing information obtained from one or more messages exchanged between the first and second devices using Wi-Fi signaling. Then, the first device determines whether to abort or continue with the commissioning or provisioning procedure, based on the estimated distance or estimated round-trip travel time. This may comprise, for instance, comparing the estimated distance or estimated round-trip travel time to a threshold value and aborting the commissioning or provisioning procedure in response to the estimated distance or estimated round-trip travel time exceeding the threshold value.

Correspondingly, embodiments described below include a wireless device comprising radio circuitry and processing circuitry configured for operation as a Wi-Fi station (STA), where the processing circuitry is further configured to use the radio circuitry to initiate or respond to initiation of a commissioning or provisioning procedure with a second device comprising a Wi-Fi STA, using Wi-Fi signaling. The processing circuitry is still further configured to determine an estimated distance or estimated round-trip travel time between the wireless device and the second device, using timing information obtained from one or more messages exchanged between the wireless device and the second device using Wi-Fi signaling, and to determine whether to abort or continue with the commissioning or provisioning procedure, based on the estimated distance or estimated round-trip travel time.

These and other techniques and apparatuses are described in further detail below.

### BRIEF DESCRIPTION OF THE FIGURES

FIG. 1 illustrates an example Neighborhood Aware Networking (NAN) Service Discovery Frame (SDF).

FIG. 2 illustrates generating shared keys from a temporary shared secret key.

FIG. 3 is a signal flow diagram illustrating the use of message integrity codes (MICs) to protect messages in a Fine Time Measurement (FTM) process.

FIG. 4 is another signal flow diagram illustrating an example procedure using the 802.11 az protocol.

FIG. 5 illustrates an example process in which secure distance measurement is integrated into the Device Provisioning Protocol (DPP).

FIG. 6 is a process flow diagram illustrating an example method according to some of the disclosed embodiments.

FIG. 7 is a block diagram illustrating an example wireless device according to disclosed embodiments.

### DETAILED DESCRIPTION

As briefly discussed above, current commissioning protocols such as CSA Matter and WFA DPP (Device Provision Protocol) may result in commissioning wrong Wi-Fi IoT devices when these protocols employ Wi-Fi communication, causing serious security breaches. This is because the communication range for Wi-Fi can be over one hundred feet, which means that several devices other than an intended target for the commissioning, i.e., the “commissionee device,” may be within range. Any device within the signal range could respond to the commissioner device, thus the possibility for the commissioner device to commission a wrong device is not negligible. Indeed, one of these devices might be controlled by a malicious actor—if it is able to complete the commissioning protocol, the result may be a serious security breach.

One solution to this problem is to limit the commissioning process to use Bluetooth Low Energy or NFC, so that the communications range is only a few feet. With this approach, it can be relatively easy to ensure that only the intended commissionee device is in close proximity to the commissioner device and thus able to complete the commissioning process. However, this approach increases the cost of Wi-Fi-based IoT devices, and can affect device size and power consumption, as the devices need to include Bluetooth or NFC radio circuitry in addition to the Wi-Fi radio.

These problems can be avoided by integrating a distance measurement procedure into a Wi-Fi-based commissioning protocol. This procedure can be used to ensure that the commissionee device is within a predetermined distance of the commissioner device.

There are existing Wi-Fi-based techniques for determining the distance between two Wi-Fi devices. For example, Wi-Fi standards 11mc and 11az have defined FTM (Fine Time Measurement) and ranging NDP (Null Data Packet) for distance measurement. However, this process should also be secure. A requirement for secure measurement is that the two devices (STAs) must share a key to protect the measurement data, which is typically not available before commissioning. For the reasons discussed above, commissioning may need distance measurement as a precondition. This creates a classic chicken and egg problem.

The techniques described herein address this issue by integrating a secure Wi-Fi distance measurement into a Wi-Fi based commissioning procedure, so that the resulting Wi-Fi-only device commissioning/configuration solution can reach the same security level as Wi-Fi+NFC or Wi-Fi+BLE solutions.

Below, details for integrating secure distance measurement into current-day Wi-Fi commissioning protocols, i.e., CSA's Matter commissioning protocol and the Wi-Fi Alliance's DPP commissioning protocol, are provided. It should be appreciated, however, that similar techniques may be used with other commissioning protocols as well. Thus, the details for the Matter and DPP commissioning protocols are followed by a generalized description of the techniques.

The terms “commissioning device,” “commissioner device,” or “commissioner” are used herein to refer to the device that controls the commissioning process, and thus controls whether a target device is commissioned, and thus granted credentials for accessing the operational network. The terms “commissionee device” or “commissionee” refer to the target device.

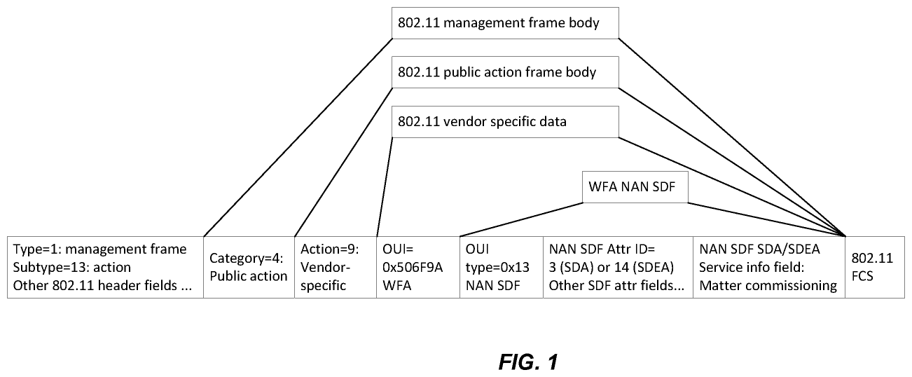

A first example of integrating a secure distance measurement into a Wi-Fi commissioning protocol is the based on the CSA Matter commissioning protocol. After a Wi-Fi commissioner device finds the commissionee device, e.g., using a discovery process, it can begin running the Matter commissioning protocol inside SDA (Service Descriptor Attribute) or SDEA (Service Descriptor Extension Attribute) fields in the Neighborhood Aware Networking (NAN) Service Discovery Frame (SDF). As shown in FIG. 1, a NAN SDF is a WFA defined data structure starting with WFA's OUI (Organization Unique Identifier) code inside an IEEE 802.11 Public Action frame. One payload type for an NAN SDF is the SDA/SDEA payload. Matter Commissioning protocol messages are embedded in the SDA/SDEA. In the SDA/SDEA's control field, the ranging_required bit can be set to indicate secure ranging is needed (the ranging_required bit already exists in current NAN protocol) during protocol exchanges.

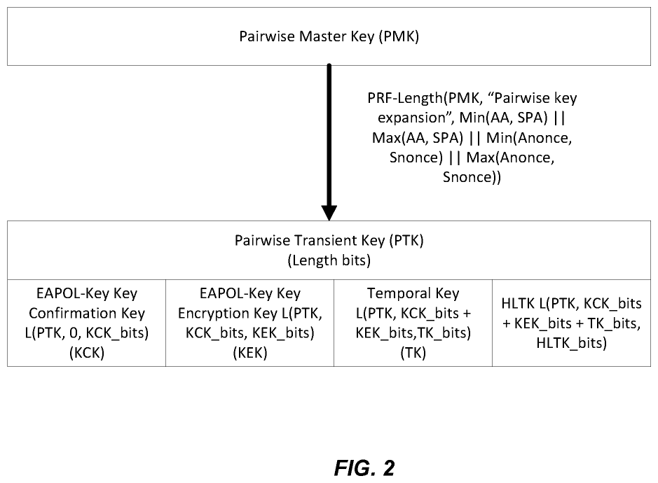

The commissioner device may use a Password-Authenticated Key Establishment (PAKE) or Certificate Authenticated Session Establishment (CASE) protocol to establish a shared secret with the commissionee device. A shared key can then be generated from the shared secret to protect FTM or ranging NDP frames. This ensures that these FTM or ranging NDP frames are exchanged between only the commissioning device and the device with which the shared key is established. More particularly, the shared secret can be used to temporarily generate a PMK (Pairwise Master Key) shared by the commissioner and commissionee, and then a Temporal Key (TK) and Higher-Layer Transient Key (HLTK) can be generated for use as the Medium Access Control (MAC) and physical (PHY) layer keys, for secure FTM and NDP ranging. An example of how to generate TK and HLTK is shown in FIG. 2.

Once the shared keys are established, the commissioner and commissionee devices can then run the 802.11mc protocol or the 802.11 az protocol, and calculate the distance between them. Note that a round-trip time (RTT) measurement may be treated as a distance measurement, as the RTT is simply the one-way distance scaled by one-half the speed of light. Thus, while a RTT might be converted to an actual distance measurement with a simple calculation, it might also be used directly, as a proxy for the actual distance. Thus, the term “distance measurement” as used herein should be understood as referring to a measurement process that yields a parameter that directly represents or is proportional to an estimated one-way distance between devices.

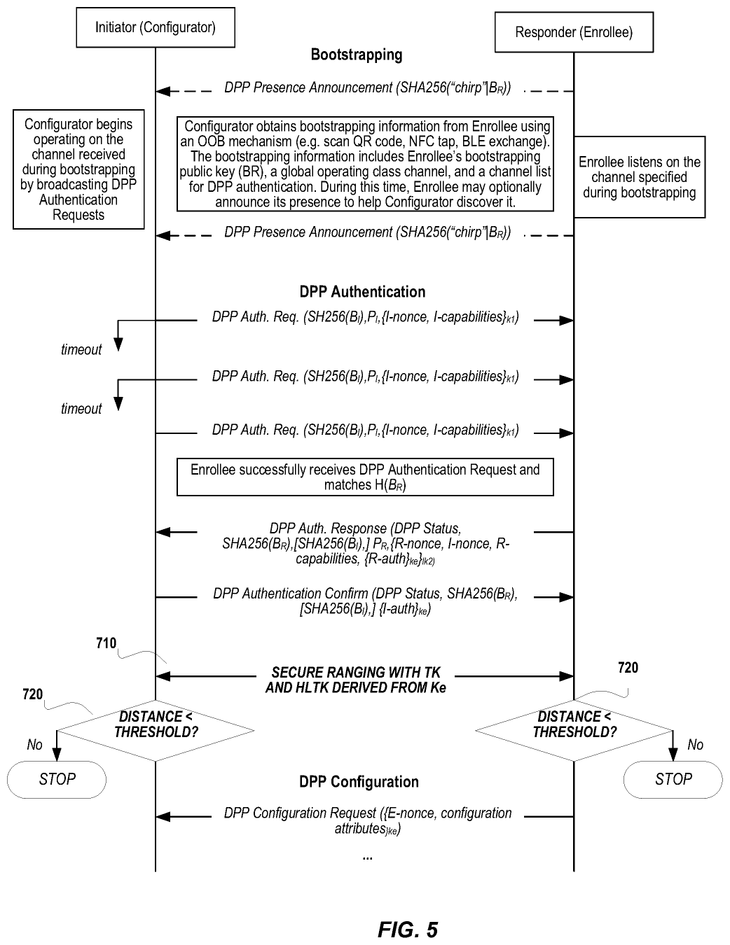

Either or both of the commissioner and commissionee can measure the distance with security protection, using the agreed-upon keys discussed above. If the 802.11mc FTM protocol is used, these keys can be used to protect the FTM measurement message, where for example, the TK key is used to generate Message Integrity Codes (MICs) for each of the exchanged messages, as shown in the example message exchange illustrated in FIG. 5. These MICs can be generated using cryptographic operations performed using the exchanged messages and the shared keys, e.g., using encryption and/or hashing operations. By sending the MIC corresponding to a given message as well as the message itself, the sender proves to the recipient that the sender is in possession of the shared secret(s), such as the TK key.

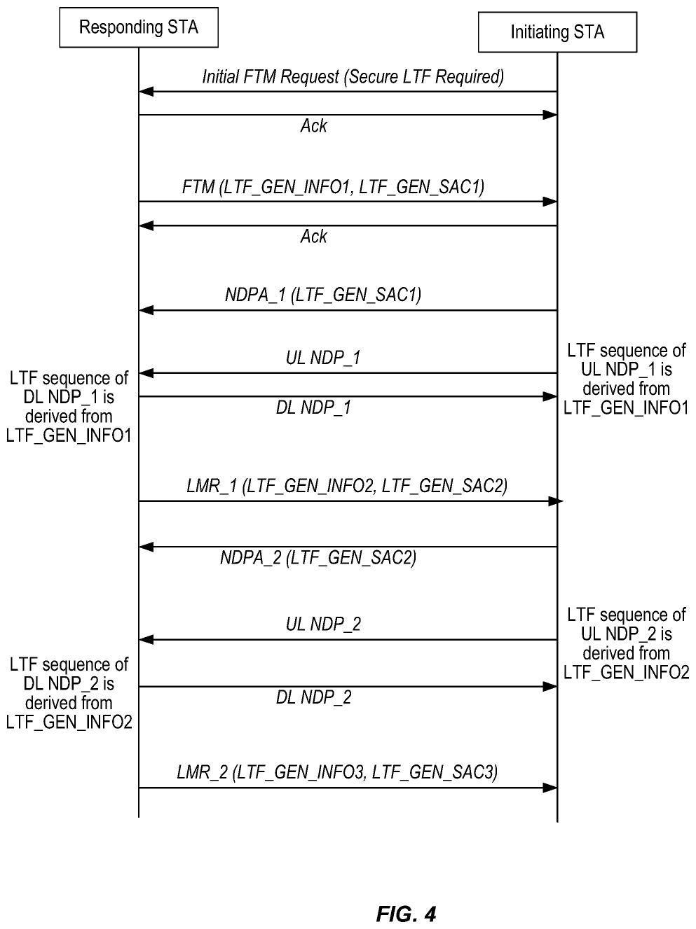

Similarly, if the 802.11 az FTM+NDP protocol is used, the security protection is defined in the 802.11 az standard, and the shared TK and HLTK keys may be used to protect MAC layer and PHY layer of the 802.11 az protocol. As shown in FIG. 4, the Initial FTM Request message may be guarded by a MIC (message integrity code) using TK; all subsequent FTM messages can also be guarded with corresponding MICs. In addition, the LTF_GEN_INFO1/2/ . . . , LTF_GEN_SAC1/2/ . . . parameters carried by those subsequent FTM messages are used to generate physical layer integrity code at 801.11ax LTF prefix, using HLTK key.

Once the distance has been securely measured, e.g., according to either of the techniques described above, the distance measurement (or equivalently, the measured round-trip time) can be evaluated to determine whether the commissioning protocol should be continued or aborted. If the measured distance is within a given threshold the commissioning protocol can proceed to the next step, otherwise the commissioning protocol is aborted. Note that this evaluation can be carried out at both ends, or only at the commissioner device, in various embodiments. Thus, when the measured distance is smaller than a predetermined threshold, the commissioner continues with the commissioning process in encrypted format with the commissionee, else, the commissioning process is abandoned.

An example implementation of the integration of secure distance measurement into the DPP commissioning protocol is illustrated in FIG. 5. The newly added steps are shown at blocks 510 and 520; the remaining steps in the figure are part of the conventional DPP protocol.

In FIG. 5, the Initiator/Configurator is the commissioner device, while the Responder/Enrollee is the commissionee. As seen in the figure, after the Configurator device and the Enrollee device finish the DPP authentication protocol successfully, a shared secret bk is generated, from which a temporary PMK can be generated, and TK and HLTK can be generated from PMK as MAC and PHY layer key for secure FTM or NDP ranging. (The generation of the TK and HLTK keys is shown in FIG. 2, discussed above.)

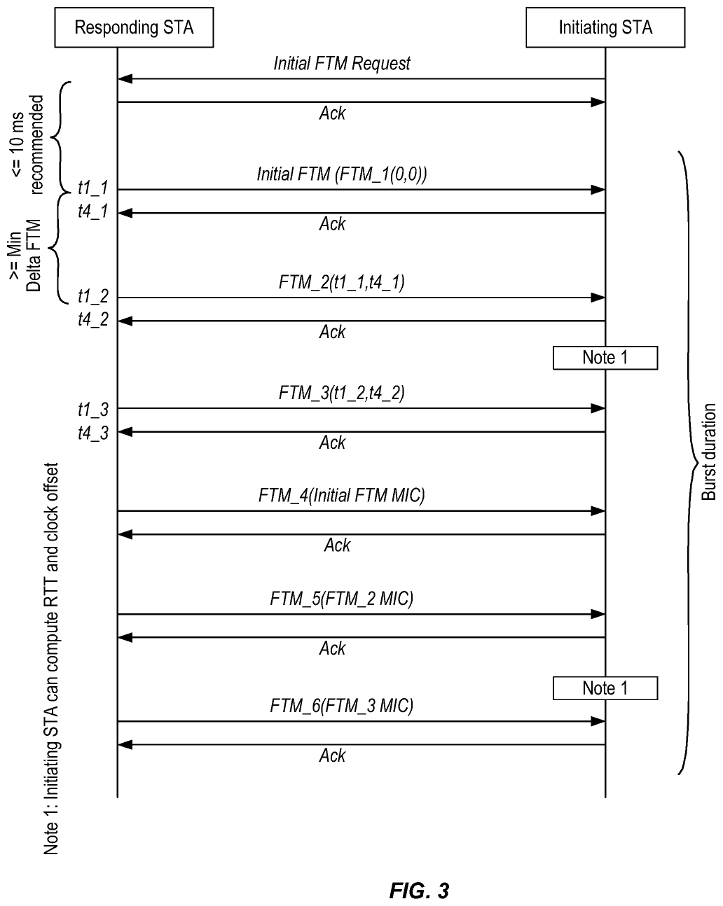

Next, the Configurator device and the Enrollee can run either the 802.11 mc or 802.11 az protocol, and calculate the distance (or, equivalently, RTT) between them. This is shown at block 510 in FIG. 5. Either or both of the Configurator and Enrollee can measure and communicate the distance with security protection. If the 802.11 mc FTM protocol is used, for example, a security protection method like that shown in FIG. 3 may be used, where the key used to generate the MICs is TK. If the 802.11az FTM+NDP protocol is used, the security protection is defined in 802.11 az standard, and TK and HLTK are used to protect MAC layer and PHY layer of 11az protocol, e.g., as was shown in FIG. 4.

Next, the measured distance (or RTT) is evaluated to determine whether the commissioning protocol should continue, as shown at block 520 of FIG. 5. If the measured distance is within a threshold specified by the Configurator, or by both Configurator and Enrollee, the process can proceed to the DPP configuration protocol, where the Configurator proceeds to send configuration data to the Enrollee in encrypted format; otherwise the DPP process is aborted.

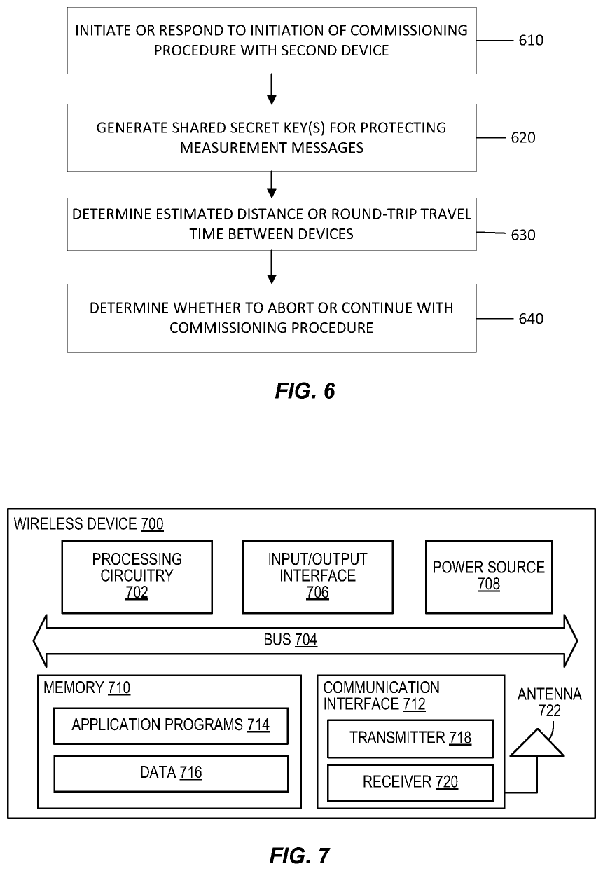

In view of the detailed examples provided above, it should be appreciated that FIG. 6 illustrates an example method in a first device comprising a Wi-Fi station (STA), where the illustrated method is intended to be a generalization of the techniques described above and to encompass those techniques. Thus, where terminology used in the description of the method shown in FIG. 6 differs somewhat from the examples and illustrations provided above, the terminology used below should be understood as interchangeable with or encompassing the similar terminology used above, except where the context makes it clear otherwise.

The method shown in FIG. 6 may be understood as applying to either or both of the commissioner device or the commissionee device. As shown at block 610, the first device initiates or responds to initiation of a commissioning or provisioning procedure with a second device comprising a Wi-Fi STA, using Wi-Fi signaling. As shown at block 630, the first device determines an estimated distance or estimated round-trip travel time between the first and second devices, using timing information obtained from one or more messages exchanged between the first and second devices using Wi-Fi signaling. Finally, as shown at block 640, the first device determines whether to abort or continue with the commissioning or provisioning procedure, based on the estimated distance or estimated round-trip travel time.

The determination of whether to abort or continue with the commissioning procedure may comprise simply comparing the measured distance or round-trip travel time with a predetermined thus. So, for example, some instances of the illustrated method may comprise comparing the estimated distance or estimated round-trip travel time to a threshold value and aborting the commissioning or provisioning procedure in response to the estimated distance or estimated round-trip travel time exceeding the threshold value. The threshold could be determined or pre-set in various ways. For example, a preset values based on device type might be used. Alternatively, the context in which the commissioning process takes place might be taken into account, e.g., using machine learning (ML) about the environment.

In some embodiments, examples of which were provided above, the one or more messages used to estimate the distance or round-trip travel time may comprise a Fine Time Measurement (FTM) or a ranging Null Data Packet (NDP). In various embodiments, determining the estimated distance or estimated round-trip travel time may comprise using the 802.11mc Fine Time Measurement (FTM) protocol or the 802.11az next-generation positioning (NGP) protocol. The use of other distance measurement or round-trip travel time estimation protocols is possible, as well.

Likewise, in some embodiments, the commissioning or provisioning procedure is the Matter commissioning protocol, and the method comprises performing the Matter commissioning protocol using Service Descriptor Attribute (SDA) or Service Descriptor Extension Attribute (SDEA) fields in Neighbor Awareness Networking (NAN) Service Discovery Frames (SDFs). In other embodiments, the commissioning or provisioning procedure is the Device Provisioning Protocol (DPP). The techniques described here may be applied to other protocols as well.

In some embodiments, the method comprises, prior to determining the estimated distance or estimated round-trip travel time, communicating with the second device to establish a shared secret, generating at least one key from the shared secret, and using the at least one key for encryption, decryption, and/or authentication of at least one of the one or more messages. This is shown at block 620 in FIG. 6. This may comprise, for example, using the Passcode-Authenticated Session Establishment (PASE) protocol or the Certificate Authenticated Session Establishment (CASE) protocol to establish the shared secret.

FIG. 7 is a block diagram illustrating an example device, in accordance with some embodiments. The illustrated device 700 may be configured, e.g., with the processing circuitry detailed below, to carry out one or several of the techniques described above.

The device 700 includes processing circuitry 702 that is operatively coupled via a bus 704 to an input/output interface 706, a power source 708, a memory 710, a communication interface 712, and/or any other component, or any combination thereof. Certain devices may utilize all or a subset of the components shown in FIG. 7. The level of integration between the components may vary from one device to another device. Further, certain devices may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the device 700. Examples of an input device include a touch-sensitive or presence-sensitive display, a camera (e.g., a digital camera, a digital video camera, a web camera, etc.), a microphone, one or more other sensors, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the device 700 via input circuitry or an interface such as an electrical power cable. Delivering power may be, for example, for charging of the power source 708. Power circuitry may perform any formatting, converting, or other modification to the power from the power source 708 to make the power suitable for the respective components of the device 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the device 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIM M), synchronous dynamic random access memory (SDRAM), external micro-DIM M SDRAM, smartcard memory, other memory, or any combination thereof. The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with a network, e.g., a Wi-Fi network, using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., device UE or an access point in a network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Device 700 may provide an output of data captured by its sensors, through its communication interface 712, via a wireless connection to a network node. Data captured by sensors can be communicated through a wireless connection to a network node. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a device comprises an actuator, a motor, or a switch, related to a communication interface configured to receive wireless input from a network node via a wireless connection. In response to the received wireless input the states of the actuator, the motor, or the switch may change. For example, the device may comprise a motor that adjusts the control surfaces or rotors of a drone in flight according to the received input or to a robotic arm performing a medical procedure according to the received input.

A device 700 in the form of an Internet of Things (IoT) device may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A device 700 in the form of an IoT device comprises circuitry and/or software in dependence of the intended application of the IoT device in addition to other components as described in relation to the UE 700 shown in FIG. 7.

As yet another specific example, in an IoT scenario, device 700 may represent a machine or other device that performs monitoring and/or measurements, and transmits the results of such monitoring and/or measurements to another device and/or a network node. In practice, any number of devices may be used together with respect to a single use case.

Thus, the presently disclosed techniques may be carried out by a wireless device, such as a wireless device having some or all of the components illustrated in FIG. 7, where the wireless device comprises radio circuitry and processing circuitry configured for operation as a Wi-Fi station (STA). In various embodiments, the processing circuitry may be configured to initiate or respond to initiation of a commissioning or provisioning procedure with a second device comprising a Wi-Fi STA, using Wi-Fi signaling, and to determine an estimated distance or estimated round-trip travel time between the wireless device and the second device, using timing information obtained from one or more messages exchanged between the wireless device and the second device using Wi-Fi signaling. The processing circuitry may be further configured to determine whether to abort or continue with the commissioning or provisioning procedure.

In some embodiments, the processing circuitry is configured to compare the estimated distance or estimated round-trip travel time to a threshold value and abort the commissioning or provisioning procedure in response to the estimated distance or estimated round-trip travel time exceeding the threshold value. The one or more messages may comprise a Fine Time Measurement (FTM) or a ranging Null Data Packet (NDP), in various embodiments. Likewise, in various embodiments, the processing circuitry may be configured to determine the estimated distance or estimated round-trip travel time using the 802.11mc Fine Time Measurement (FTM) protocol or the 802.11az next-generation positioning (NGP) protocol.

In some embodiments, the commissioning or provisioning procedure is the Matter commissioning protocol, and the processing circuitry is configured to perform the Matter commissioning protocol using Service Descriptor Attribute (SDA) or Service Descriptor Extension Attribute (SDEA) fields in Neighbor Awareness Networking (NAN) Service Discovery Frames (SDFs). In other embodiments, the commissioning or provisioning procedure is the Device Provisioning Protocol (DPP).

In various embodiments, the processing circuitry is further configured to communicate with the second device to establish a shared secret and generate at least one key from the shared secret, prior to determining the estimated distance or estimated round-trip travel time, and to use the at least one key for encryption, decryption, and/or authentication of at least one of the one or more messages. In some embodiments, the processing circuitry may be configured to use Passcode-Authenticated Session Establishment (PASE) protocol or Certificate Authenticated Session Establishment (CASE) protocol to establish the shared secret.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method, in a first device comprising a Wi-Fi station (STA), the method comprising:
initiating or responding to initiation of a commissioning or provisioning procedure with a second device comprising a Wi-Fi STA, using Wi-Fi signaling, wherein the commissioning or provisioning procedure is the Matter commissioning protocol or the Device Provisioning Protocol (DPP);
determining an estimated distance or estimated round-trip travel time between the first and second devices, using timing information obtained from one or more messages exchanged between the first and second devices using Wi-Fi signaling;
based on the estimated distance or estimated round-trip travel time, determining whether to abort or continue with the commissioning or provisioning procedure.

2. The method of claim 1, wherein the method comprises comparing the estimated distance or estimated round-trip travel time to a threshold value and aborting the commissioning or provisioning procedure in response to the estimated distance or estimated round-trip travel time exceeding the threshold value.

3. The method of claim 1, wherein the one or more messages comprise a Fine Time Measurement (FTM) or a ranging Null Data Packet (NDP).

4. The method of claim 1, wherein the commissioning or provisioning procedure is the Matter commissioning protocol, and wherein the method comprises performing the Matter commissioning protocol using Service Descriptor Attribute (SDA) or Service Descriptor Extension Attribute (SDEA) fields in Neighbor Awareness Networking (NAN) Service Discovery Frames (SDFs).

5. The method of claim 1, wherein the commissioning or provisioning procedure is the DPP.

6. The method of claim 1, wherein the method further comprises, prior to determining the estimated distance or estimated round-trip travel time:
communicating with the second device to establish a shared secret;
generating at least one key from the shared secret; and
using the at least one key for encryption, decryption, and/or authentication of at least one of the one or more messages.

7. The method of claim 6, wherein the method comprises using Passcode-Authenticated Session Establishment (PASE) protocol or Certificate Authenticated Session Establishment (CASE) protocol to establish the shared secret.

8. The method of claim 1, wherein determining the estimated distance or estimated round-trip travel time comprises using the 802.11mc Fine Time Measurement (FTM) protocol or the 802.11az next-generation positioning (NGP) protocol.

9. A wireless device comprising radio circuitry and processing circuitry configured for operation as a Wi-Fi station (STA), wherein the processing circuitry is further configured to, using the radio circuitry:
initiate or respond to initiation of a commissioning or provisioning procedure with a second device comprising a Wi-Fi STA, using Wi-Fi signaling, wherein the commissioning or provisioning procedure is the Matter commissioning protocol or the Device Provisioning Protocol (DPP);
determine an estimated distance or estimated round-trip travel time between the wireless device and the second device, using timing information obtained from one or more messages exchanged between the wireless device and the second device using Wi-Fi signaling;
based on the estimated distance or estimated round-trip travel time, determine whether to abort or continue with the commissioning or provisioning procedure.

10. The wireless device of claim 9, wherein the processing circuitry is configured to compare the estimated distance or estimated round-trip travel time to a threshold value and abort the commissioning or provisioning procedure in response to the estimated distance or estimated round-trip travel time exceeding the threshold value.

11. The wireless device of claim 9, wherein the one or more messages comprise a Fine Time Measurement (FTM) or a ranging Null Data Packet (NDP).

12. The wireless device of claim 9, wherein the commissioning or provisioning procedure is the Matter commissioning protocol, and wherein the processing circuitry is configured to perform the Matter commissioning protocol using Service Descriptor Attribute (SDA) or Service Descriptor Extension Attribute (SDEA) fields in Neighbor Awareness Networking (NAN) Service Discovery Frames (SDFs).

13. The wireless device of claim 9, wherein the commissioning or provisioning procedure is the DPP.

14. The wireless device of claim 9, wherein the processing circuitry is further configured to communicate with the second device to establish a shared secret and generate at least one key from the shared secret, prior to determining the estimated distance or estimated round-trip travel time, and to use the at least one key for encryption, decryption, and/or authentication of at least one of the one or more messages.

15. The wireless device of claim 14, wherein the processing circuitry is configured to use Passcode-Authenticated Session Establishment (PASE) protocol or Certificate Authenticated Session Establishment (CASE) protocol to establish the shared secret.

16. The wireless device of claim 9, wherein the processing circuitry is configured to determine the estimated distance or estimated round-trip travel time using the 802.11mc Fine Time Measurement (FTM) protocol or the 802.11az next-generation positioning (NGP) protocol.
